(19) United States
(12) Patent Application Publication
(10) Pub. No.: US 2024/0300120 A1
(43) Pub. Date: Sep. 12, 2024

(54) FLEXIBLE FINGERS, ROBOTIC GRASPING DEVICES EQUIPPED THEREWITH, AND METHODS OF USING

(71) Applicant: Purdue Research Foundation, West Lafayette, IN (US)

(72) Inventors: Dongming Gan, West Lafayette, IN (US); Jiaming Fu, West Lafayette, IN (US)

(21) Appl. No.: 18/179,163

(22) Filed: Mar. 6, 2023

Related U.S. Application Data
(60) Provisional application No. 63/338,992, filed on May 6, 2022.

(51) Int. Cl. B25J 15/12; B25J 15/02

(52) U.S. Cl. CPC B25J 15/12; B25J 15/0293

(57) ABSTRACT

Fingers for robotic grasping devices, robotic grasping devices equipped therewith, and associated methods. Such a finger includes a flexible beam mechanism having an axis extending through a proximal end and a distal end, and a slider movably mounted on the beam. Moving the slider along the axis of the flexible beam mechanism changes the stiffness of the finger.

### CROSS-REFERENCE TO RELATED APPLICATIONS

This application claims the benefit of U.S. Provisional Application No. 63/338,992 filed May 6, 2022, the contents of which are incorporated herein by reference.

### STATEMENT REGARDING FEDERALLY SPONSORED RESEARCH

This invention was made with government support under grant number FRR-2131711 awarded by National Science Foundation. The government has certain rights in the invention.

### BACKGROUND OF THE INVENTION

The invention generally relates to robotic devices, and particularly relates with robotic grasping devices, fingers therefor, and methods of making and/or using the same.

Robotic grasping devices, commonly referred to as grippers or graspers, are increasingly important for robot applications. Most robotic grasping devices include a set of rigid joints and beams, resulting in a lack of flexibility when grasping. This makes it difficult for robots to adapt to some working conditions, especially for human-robot interaction.

More recently, robotic devices composed of joints and/or beams formed of compliant materials have been favored because of their good adaptability, compliance, and safety, especially for soft robotic grasping devices. Compared with rigid robotic devices, such “soft” robotic devices have significant advantages. As examples, they are safer in the event of a collision with a human or object, and soft grasping devices can better adapt to the shape and position of an object, enabling the grasping device to more securely and safely grip fragile objects. However, soft robotic grasping devices also have shortcomings, such as small contact forces, lower positioning accuracy, complex motion models, and higher control difficulties.

Variable-stiffness robotic grasping devices are directed to solving the above problems by actively adjusting their stiffness according to their condition of operation in a variety of applications. Some variable-stiffness grasping devices incorporate variable-stiffness materials such as shape-memory polymer, composite materials, magnetorheological fluid, and dielectric elastomer. However, known designs of this nature tend to have a small range of stiffness, small driving forces, complex assemblies, and/or limited controllability. Other variable-stiffness grasping devices change the mechanical structure property. However, these also have a limited range of stiffness adjustment.

It would be desirable if soft robotic grasping devices were available that are capable of exhibiting variable compliance/stiffness for flexible grasping with a high range stiffness adjustment.

### BRIEF SUMMARY OF THE INVENTION

The intent of this section of the specification is to briefly indicate the nature and substance of the invention, as opposed to an exhaustive statement of all subject matter and aspects of the invention. Therefore, while this section identifies subject matter recited in the claims, additional subject matter and aspects relating to the invention are set forth in other sections of the specification, particularly the detailed description, as well as any drawings.

The present invention provides, but is not limited to, flexible fingers capable of use in robotic grasping devices, robotic grasping devices equipped therewith, and methods for their use.

According to a nonlimiting aspect of the invention, a flexible finger for a robotic grasping device includes a flexible beam mechanism having an axis extending through a proximal end and a distal end, and a slider movably mounted on the beam. Moving the slider along the axis of the flexible beam mechanism changes the stiffness of the finger.

According to another nonlimiting aspect of the invention, a robotic grasping device is provided that includes a flexible finger as described above.

According to still another nonlimiting aspect of the invention, a method of adjusting the stiffness of a variable-stiffness robotic finger includes moving a slider continuously along an axis of a flexible beam mechanism of the finger.

Technical aspects of fingers, robotic grasping devices, and methods as described above preferably include the capability of providing rapid changes in stiffness, large stiffness change ratios, and/or potentially lower cost solutions.

Other aspects and advantages will be appreciated from the following detailed description.

### BRIEF DESCRIPTION OF THE DRAWINGS

FIG. 1 is a perspective view of a schematic representation of a robotic grasping device according to some nonlimiting aspects of the present invention.

FIG. 2 contains side and front views of a parametric model of a finger of the robotic grasping device of FIG. 1, and depicts a slider that can be adjustably positioned along a length of the finger.

FIGS. 3A and 3B depict a finite element analysis mesh model (FIG. 3A) and simulation result (FIG. 3B) of a finger of the robotic grasping device of FIG. 1.

FIGS. 4A-4H show graphs of stiffness and deformation varying with different design parameters for a finger of the robotic grasping device of FIG. 1.

FIGS. 5A-5D show error varying with different design parameters for a finger of the robotic grasping device of FIG. 1.

FIG. 6 shows results of experimental tests with different slider-occupied ratios λ for a finger of the robotic grasping device of FIG. 1.

FIG. 7 shows stiffness varying with different slider-occupied ratios λ for a finger of the robotic grasping device of FIG. 1.

### DETAILED DESCRIPTION OF THE INVENTION

The intended purpose of the following detailed description of the invention and the phraseology and terminology employed therein is to describe what is shown in the drawings, which include the depiction of or relate to one or more nonlimiting embodiments of the invention, and to describe certain but not all aspects of what is depicted in the drawings, including the embodiment(s) to which the drawings relate. The following detailed description also describes certain investigations relating to the embodiment(s) depicted in the drawings, and identifies certain but not all alternatives of the embodiment(s). As nonlimiting examples, the invention encompasses additional or alternative embodiments in which one or more features or aspects shown and/or described as part of a particular depicted embodiments could be eliminated, and also encompasses additional or alternative embodiments that combine two or more features or aspects shown and/or described as part of different embodiments. Therefore, the appended claims, and not the detailed description, are intended to recite what at least provisionally are believed to be aspects of the invention, including certain but not necessarily all of the aspects and alternatives described in the detailed description.

To facilitate the description provided below of the embodiment(s) represented in the drawings, relative terms, including but not limited to, “proximal,” “distal,” “anterior,” “posterior,” “vertical,” “horizontal,” “lateral,” “front,” “rear,” “side,” “forward,” “rearward,” “top,” “bottom,” “upper,” “lower,” “above,” “below,” “right,” “left,” etc., may be used in reference to the orientation of the grasping device and finger during its use and/or as represented in the drawings. All such relative terms are useful to describe the illustrated embodiment(s) but should not be otherwise interpreted as limiting the scope of the invention.

A robotic grasping device (also referred to as a gripper or grasper) of the present disclosure includes one or more fingers having a reconfigurable beam assembly. The grasping device can adapt to various different gripping tasks without replacing the finger by instead controlling the stiffness of the finger through modifying its mechanical structure. According to a nonlimiting embodiment of the invention, such modifications can be accomplished by constructing the finger to comprising at least two flexible beams and a slider movably mounted to the flexible beams in a manner that enables the stiffness of the finger to be altered by changing the position of the slider along the lengths of the flexible beams. The process of stiffness adjustment can be achieved with mechanical inputs that can be both rapid and accurate. Adjustment of the stiffness of the finger is preferably independent of the movement of the finger.

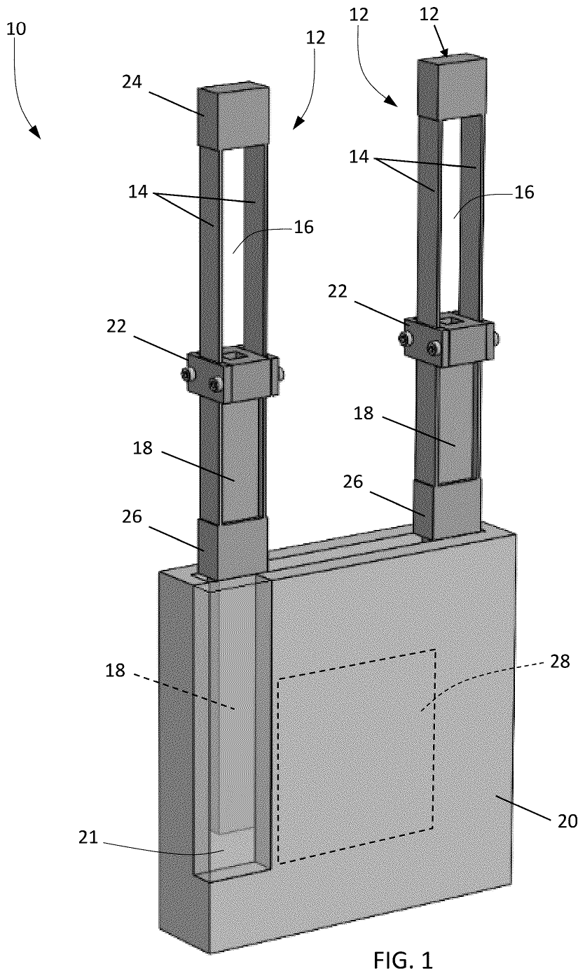

Turning now to the nonlimiting embodiments represented in the drawings, FIG. 1 depicts a robotic grasping device 10 incorporating an opposing pair of flexible fingers 12 according to nonlimiting aspects of the invention. The grasping device 10 is represented as having two fingers 12 extending from a base portion 20 of the device 10. Alternatively, a single finger 12 or any number of such fingers 12 may be incorporated into the grasping device 10. The fingers 12 are represented as being parallel to each other and spaced apart from each other a uniform distance along their lengths, although other configurations are possible. In this example, the base portion 20 is shown in a form similar to a “palm” of a hand, with the fingers 12 extending therefrom and being fixedly connected to the palm at the proximal ends thereof. However, the base portion 20 may take other forms, and/or the fingers 12 may be connected with the base portion 20 to allow some form of relative rotational movement.

Each finger 12 comprises a flexible beam mechanism that extends from the base portion 20 of the device 10. The nonlimiting flexible beam mechanism of each finger 12 is represented in FIG. 1 as comprising two flexible beams 14, which are represented as being parallel to each other and spaced apart from each other a uniform distance along their lengths to define a space 16 therebetween. Proximal ends of the flexible beams 14 are secured to the base portion 20, for example, with what is referred to herein as a root connector 26 disposed at the proximal end of each finger 12 adjacent the base portion 20. The root connector 26 may be defined by part of the base portion 20 or may be a separate component assembled to the base portion 20. The base portion 20 restrains movement of the fingers 12 in one or more movements. The oppositely-disposed distal end of each finger 12 is unrestrained, and the flexible beams 14 are shown as secured together with what is referred to herein as a head connector 24 disposed at the distal end of their respective finger 12.

The flexible beams 14 of a finger 12 form a functional pair of flexible elements of their associated beam mechanism. The space 16 between the flexible beams 14 of a finger 12 extends along the axial lengths of the beams 14 and is continuous between the root connector 26 to the head connector 24. Each flexible beam 14 is preferably formed of a resilient or pliable material, such as a metal or plastic material, that is sufficiently resilient and flexible to enable the fingers 12 to elastically flex when grasping and retaining an object therebetween, as generally described herein.

A slider 18 is slidably mounted on each finger 12 between the beams 14 thereof and at least partially within the space 16 therebetween. In the nonlimiting embodiment of FIG. 1, in the portion of a finger 12 in which the slider 18 is present, the slider 18 is shown as entirely filling the lateral distance formed by the space 16 between two beams 14, though it is foreseeable that the slider 18 may only partially occupy the space 16 (both scenarios will be referred to herein as “occupied”). The slider 18 is coupled to its associated beams 14 with a restrictor 22 disposed at a distal end of the slider 18 relative to the base portion 20, and a proximal end of each slider 18 is received in a cavity or channel 21 within the base portion 20. As a result, the slider 18 remains securely (and yet slidably) coupled to the base portion 20 and the flexible beams 14 of its corresponding finger 12, and the slider 18 is able to move in the axial direction along the length of the pair of beams 14 between the head and root connectors 24 and 26 of its finger 12 by sliding along the beams 14. The restrictor 22 is able to move back and forth along the beams 14 to the distal end of its finger 12 adjacent the head connector 26 and to the proximal end of the finger 12 adjacent the root connector 26. In the nonlimiting embodiment of FIG. 1, moving the restrictor 22 all the way to the distal end of the beams 14 causes the slider 18 to completely occupy the space 16, thereby functionally eliminating the space 16, and conversely moving the restrictor 22 all the way to the proximal end of the beams 14 causes the slider 18 to fully vacate the space 16. The stiffness of the finger 12 can be changed by changing the ratio of the occupied and vacated portions of the space 16 that are occupied and vacated, respectively, by the slider 18, for example, the ratio of the volume (size) of the space 16 occupied by the slider 18 to the total volume (size) of the remaining space 16 that is not occupied by the slider 18. The stiffness of the finger 12 decreases as the occupied ratio decreases, and the stiffness of the finger 12 increases as the occupied ratio increases. As such, when the occupied ratio is lowest (at a minimum), that is, when the slider 18 occupies the least amount of the space 16, the finger stiffness is at a minimum. When the slider 18 completely occupies the space 16, that is, when the occupied ratio is highest (at a maximum), the finger stiffness is at a maximum. Occupying the space 16 with the slider 18 changes the second area moment of inertia and the ratio of the hollow beam (i.e., the portion with the unoccupied space 16) over solid beam (i.e., the portion with the space 16 occupied by the slider 18) of the parallel beam mechanism and correspondingly its output stiffness.

One or more drive mechanisms 28 can be utilized to move the slider 18 axially back and forth along the axis of the finger 12. In this arrangement, the drive mechanism 28 extends and retracts the slider 18 in and out of the base portion 20 along the axis of the finger 12. The drive mechanism 28 may be any mechanism suitable for moving the slider 18 continuously between the distal and proximal ends of the beams 14. For example, the slider 18 can be driven by a stepper motor to change the stiffness continuously. Other types of drive mechanisms are also possible.

Investigations leading to the present invention are described below. These investigations involved experimental studies relative to one or more of the methods, materials, components, and/or devices of a grasping device such as described above in reference to FIG. 1. The descriptions of these studies include nonlimiting examples that are not to be construed as limitations or absolute requirements for the invention. Any theoretical conclusions and considerations are not meant to limit the scope of the invention.

A comprehensive stiffness model was developed based on beam superposition principles and compared with a finite element analysis (FEA) model.

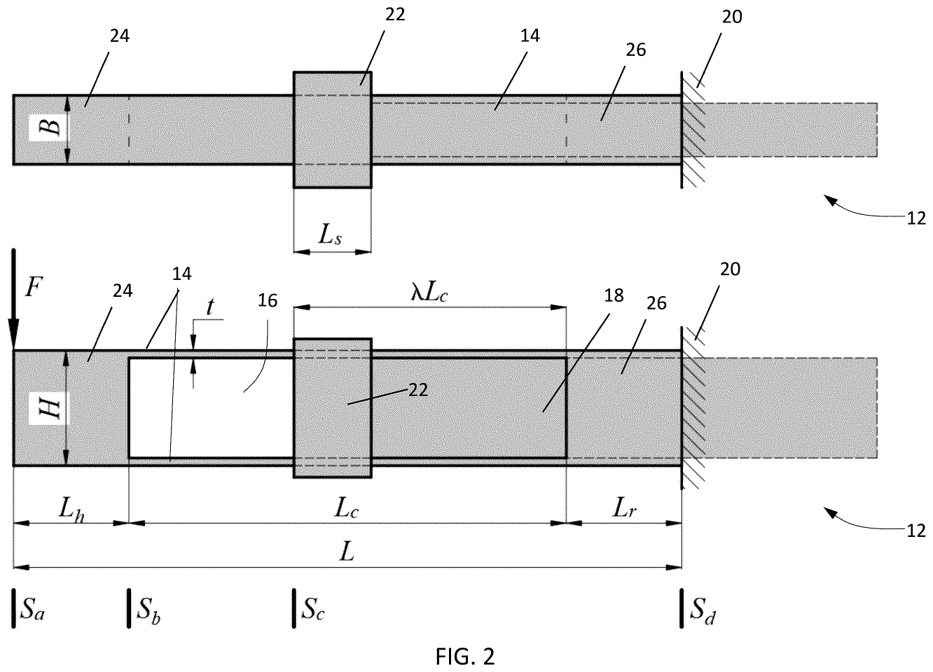

FIG. 2 shows two views of a parametric model of an exemplary variable-stiffness finger mechanism. The finger 12 can be divided into three main parts, a part SₐS_{b} at the distal end of the finger 12 (fingertip) that is intended to contact grasped objects, a part S_{c}S_{d} adjacent the proximal end of the finger 12, and a flexible part S_{b}S_{c} therebetween. Section S_{d} is fixed in the base portion 20 of the robot grasping device 10, and part SₐS_{b} corresponds to the head connector 24 of the finger 12. The lengths of the head connector 24 and root connector 26 are Lₕ and Lᵣ, respectively. The effective height of the finger 12 is unified as H and the effective thickness is unified as B. The thickness of the slider 18 is slightly less than the thickness of the beams 14, which is simplified for calculation convenience. The length of the space 16 between beams 14 is L_{c}. A ratio, λ, is designated as that portion of the space 16 occupied by the slider 18. In this analysis, the range of the slider-occupied ratio λ is varied from 0.1 to 1.0. When λ=0.1, the slider 18 is at the rightmost end adjacent the root connector 26, and the proportion of the unoccupied space 16 is highest. But since the restrictor 22 still needs some space, λ is greater than 0. When λ=1.0, the slider 18 is at the leftmost end adjacent the head connector 24 and the entire space 16 is occupied by the slider 18. The lengths for the SₐS_{b}, S_{b}S_{c}, and S_{c}S_{d} parts are Lₕ, (1λ) L_{c}, and λ L_{c}+Lᵣ, respectively. When a force F is applied to the section Sₐ, the finger 12 deforms. The deformation in the thickness direction was ignored because it is very small relative to the deformation in the direction of force F. In the direction of F (lateral direction relative to the primary axis of the finger 12), the deflection is greater in the S_{b}S_{c} part, and the deflections in the SₐS_{b} and S_{c}S_{d} parts are small, but were not ignored because they have a certain thickness and their elasticity can have a significant impact on the accuracy of the model.

The moment of inertia of the SₐS_{b} and S_{c}S_{d} parts is

$${I}_{t} = {I}_{b} = {H}^{3} B / 12 \qquad Equation 1$$

The thickness of each flexible beam 14 is t. The moment of inertia of the S_{b}S_{c} part is

$${I}_{m} = {t}^{3} B / 12 \qquad Equation 2$$

Depending on the moment of inertia, the deflection of the three parts of the finger 12 was calculated segment by segment. Then the results were finally combined together to obtain the total deflection of each part acting on section Sₐ.

Firstly, S_{b}S_{c} and S_{c}S_{d} parts were assumed as rigid bodies, meaning they are fixed and cannot deform. Then the deflection angle θₐ and displacement δₐ of the section Sₐ with respect to the other two parts are

$${θ}_{a} = \frac{{FL}_{h}^{2}}{2 {EI}_{t}} \qquad Equation 3$$

$${δ}_{a} = \frac{{FL}_{h}^{3}}{3 {EI}_{t}} \qquad Equation 4$$

where E is Young's modulus. Secondly, SₐS_{b} and S_{c}S_{d} parts were assumed as rigid bodies. The deflection only occurs in the S_{b}S_{c} part. It is affected by the force conducted from the SₐS_{b} part. According to the theory of the parallel guide mechanism, the deflection angle in S_{b}S_{c} part also affects the deformation of section Sₐ. Then superimposed on the deformation of the S_{b}S_{c} part, the total contribution of the deformation of S_{b}S_{c} part to the deformation of section Sₐ can be obtained. The deflection angle θ_{b} and displacement δ_{b} of the middle part are

$${θ}_{h} = \frac{{\dot{r}}^{2}}{6 {( H - 2 t )}^{2}} \{ \frac{{FL}_{h} [ ( 1 - λ ) {L}_{c} ]}{{EI}_{m}} + \frac{{F [ ( 1 - λ ) {L}_{c} ]}^{2}}{2 {EI}_{m}} \} \qquad Equation 5$$

$${δ}_{ab} = {θ}_{b} {L}_{h} \qquad Equation 6$$

$${δ}_{b} = \frac{{F [ ( 1 - λ ) {L}_{c} ]}^{3}}{24 {EI}_{m}} \qquad Equation 7$$

Then SₐS_{b} and S_{b}S_{c} parts were assumed as rigid bodies. The S_{c}S_{d} part is affected by force F and generates a deflection angle θ_{c} f and displacement δ_{c} f. In addition, the effect of the bending moment F[Lₕ+(1−λ)L_{c}] cannot be ignored. It can produce a deflection angle θ_{cm} and a displacement δ_{cm}. These eventually are transmitted to section Sₐ, causing deformation

$${θ}_{cf} = \frac{{F ( {L}_{r} + λ {L}_{c} )}^{2}}{2 {EI}_{b}^{2}} \qquad Equation 8$$

$${δ}_{cf} = \frac{{F ( {L}_{r} + λ {L}_{c} )}^{3}}{3 {EI}_{b}^{2}} \qquad Equation 9$$

$${θ}_{cm} = \frac{F [ {L}_{h} + ( 1 - λ ) {L}_{c} ] ( {L}_{r} + λ {L}_{c} )}{{EI}_{b}^{2}} \qquad Equation 10$$

$${δ}_{cm} = \frac{F [ {L}_{h} + ( 1 - λ ) {L}_{c} ] {( {L}_{r} + λ {L}_{c} )}^{2}}{2 {EI}_{b}^{2}} \qquad Equation 11$$

$${δ}_{ac} = ( {θ}_{bf} + {θ}_{bm} ) [ {L}_{h} + ( 1 - λ ) {L}_{c} ] \qquad Equation 12$$

$${δ}_{c} = {δ}_{cf} + {δ}_{cm} \qquad Equation 13$$

Finally, the above displacements acting on section Sₐ were added up to obtain the total displacement.

$$δ = {δ}_{a} + {δ}_{a b} + {δ}_{b} + {δ}_{a c} + {δ}_{c} \qquad Equation 14$$

Then the stiffness is

$$k = \frac{F}{δ} \qquad Equation 15$$

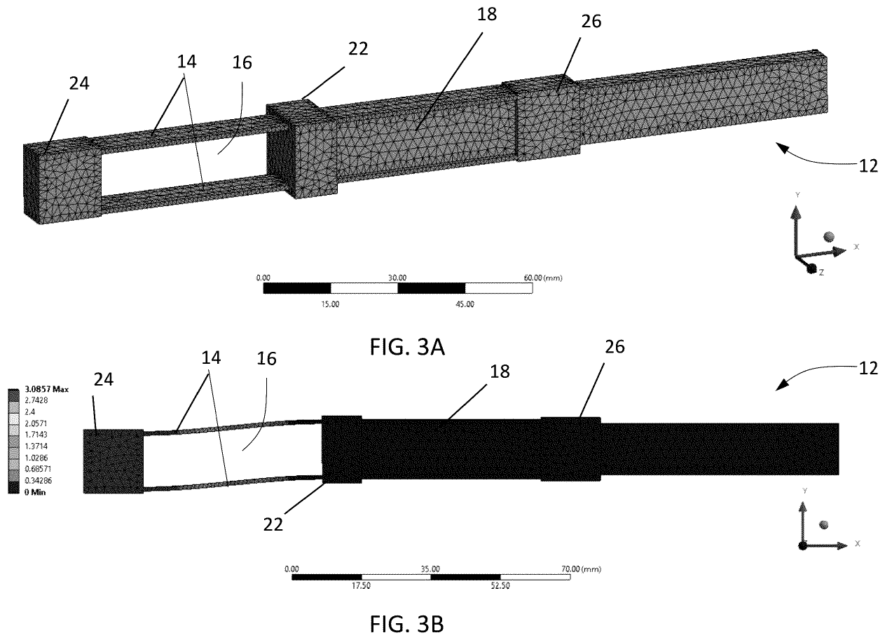

In order to verify the accuracy of the theoretical model and to investigate the effect of various design parameters on finger performance, an FEA method was performed using ANSYS. In the model, section S_{d} of the finger 12 is fixed, and a force is applied at section Sₐ. Mesh size is set as 1 mm, as shown in FIG. 3A. In the example in FIG. 3B, the occupied ratio λ was chosen at the average of the maximum and minimum values, giving λ=0.55. The applied force F was 2 N after testing the load capacity of the designed finger mechanism. It can be seen that the finger deformation occurred as expected. The deformation of the space 16 was large while that of the slider 18 was small. The deformation was recorded and used to calculate stiffness k divided by the applied force F, which was compared with the theoretical value in the following section.

Explored parameters are shown in Table 1, below. The key parameters included the finger height H, thickness B, parallel beam thickness t, and space 16 length L_{c}. When one of these parameters was changed, the other parameters remained unchanged.

TABLE 1
Key Parameters.

| Parameters | | | | |
|---|---|---|---|---|
| (mm) | Group 1 | Group 2 | Group 3 | Group 4 |
| H | 11~19 | 15 | 15 | 15 |
| t | 1 | 0.6~1.4 | 1 | 1 |
| B | 9 | 9 | 5~13 | 9 |
| L_{c} | 100 | 100 | 100 | 60~140 |
| Lₕ | 15 | 15 | 15 | 15 |
| Lᵣ | 15 | 15 | 15 | 15 |

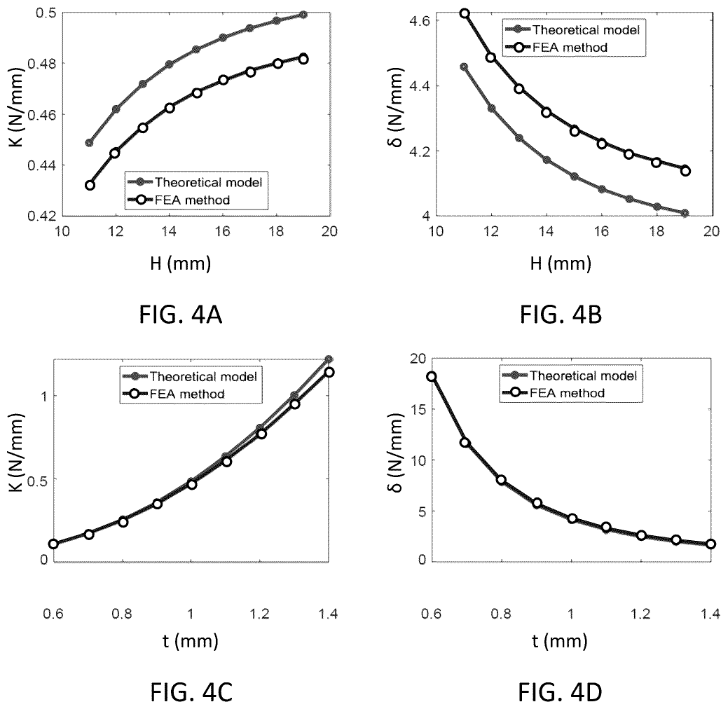

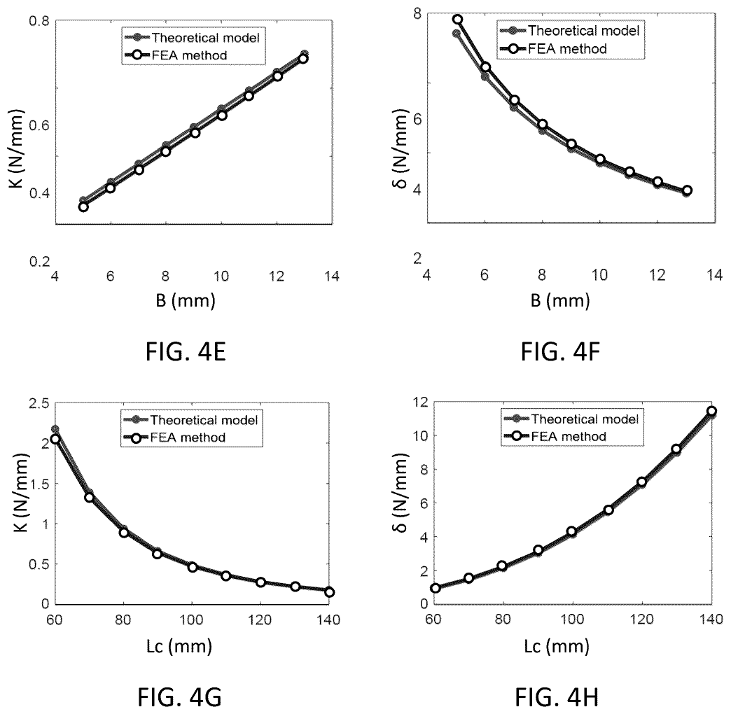

The performance of the finger 12 with different parameters is shown in FIGS. 4A through 4H. It can be seen that the stiffness of the finger 12 increased with the height of the finger H, the thickness of the flexible beam t (beams 14), and the thickness of the finger B, and decreased with the length of the space L_{c}. The trend of deformation was opposite to that of stiffness. The stiffness was more sensitive when H was small, as shown in FIG. 4(a). This was because it is difficult for the deformation of the non-space to affect the total deformation when H is large. The stiffness is more sensitive when t is large, as shown in FIG. 4C. Because its contribution to the total stiffness becomes increasingly non-negligible when t is large. The relationship between the thickness B and the stiffness was linear, as shown in FIG. 4E. The stiffness was more sensitive when L_{c} was small, as shown in FIG. 4G. The lengths of the head connector 24 and root connector 26, Lₕ and Lᵣ, were fixed. The space 16 contributes more to the deformation. When L_{c} was small, the proportion of the space L/L was small, and the stiffness was more sensitive.

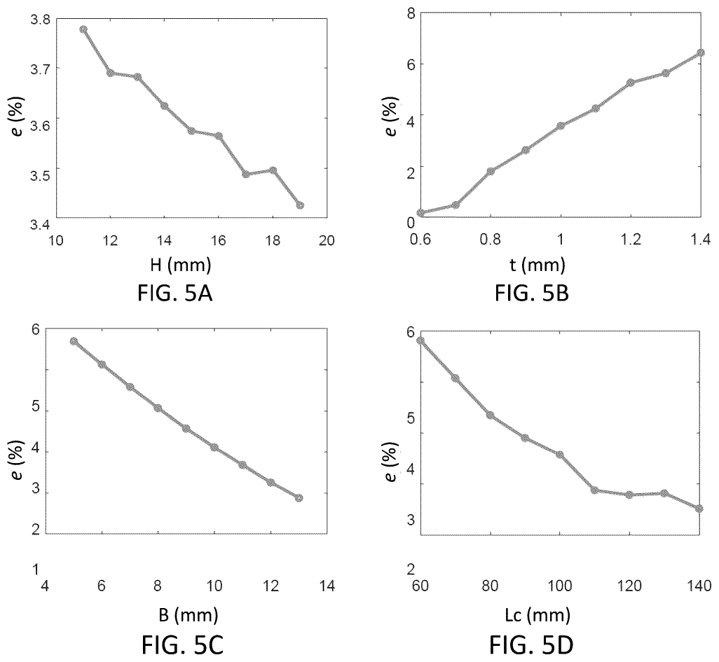

A comparison of the two methods shows that the theoretical method yields a greater stiffness for a general given condition. Using the FEA results as benchmarks, errors of the theoretical model e with different parameters are shown in FIGS. 5A through 5D. The maximum error occurs when t=1.4 mm, reaching 6.44% which quite low in compliant mechanism analysis. This result verifies the accuracy of the theoretical model.

A prototype finger was fabricated for experimental test, and a demonstration was performed to show the application scenarios of the finger.

A 3D printing method was used to produce the prototype finger. Based on a general dimension estimation and the previous theoretical analysis, design parameters of the finger were selected as shown in Table 2 below. The printing material was polylactic acid, and the infill parameter was 60%. Its Young's modulus E was 2600 MPa by experimental measurement. MARK-10 ESM303 Motorized Tension/Compression Test Stand was used to obtain the force and deformation of the finger. The root connector of the finger was fixed on the vise, and the other end was free to apply the simulated contact forces by the tester probe moving from up to down. To avoid overloading the test piece, the applied force was up to 3 N. The force and travel distance were recorded during this process for stiffness calculation.

TABLE 2
Finger Parameters.

| Parameters | |
|---|---|
| (mm) | value |
| H | 15 |
| t | 1 |
| B | 9 |
| L_{c} | 100 |
| Lₕ | 15 |
| Lᵣ | 15 |

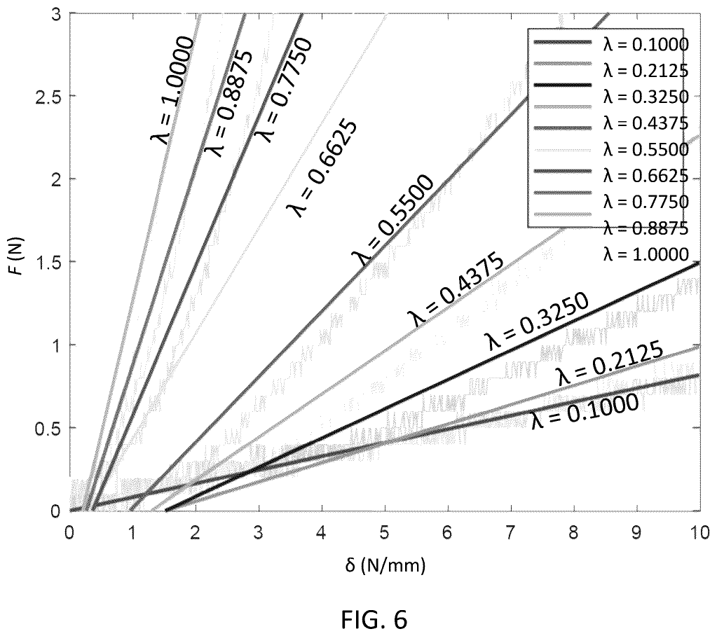

FIG. 6 shows the fitted lines of the experimental data. But it can be seen that when λ was large, the linear relationship between the applied force and deformation was getting worse due to the major difference between the beginning period and the rest deformation process, meaning the stiffness k was no longer a constant. This was mainly due to the artificial setting of the assembly clearance during the production of the finger. When λ was small, the impact of these clearances on the overall deformation was negligible as a percentage. However, when λ was large, the overall deformation becomes smaller, and the clearances have a significant impact on the overall deformation.

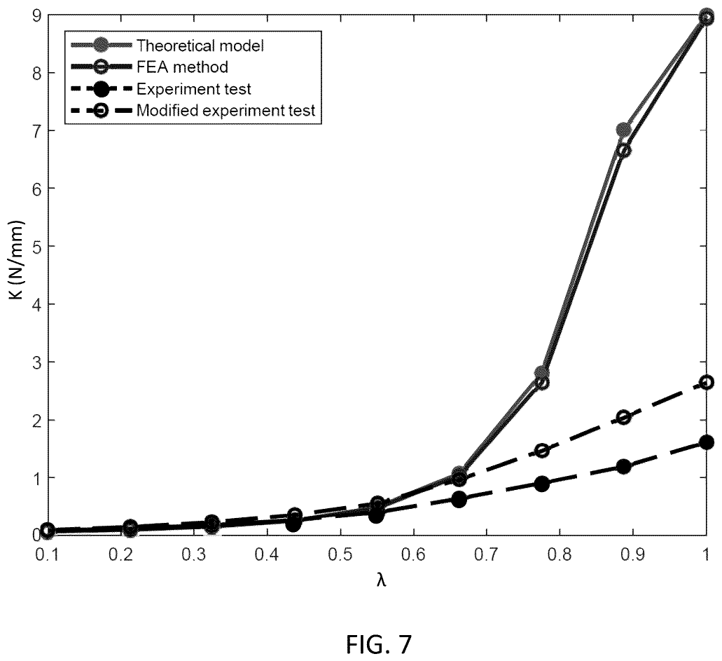

Stiffness at different λ was obtained by linearly fitting the force and deformation. The results were compared between the theoretical model and the FEA method, as shown in FIG. 7. Although changing of λ was equally spaced, the corresponding change of stiffness was not linear. The larger the λ is, the greater the changing of stiffness will be. The stiffness range ratios of the theoretical method and FEA method were 140.85 and 142.45 respectively. But the stiffness range ratio of the experimental test was 19.62. It was noticed that the theoretical model and the FEA method have the similar results, and the empiric stiffness was lower than those from the other two methods, especially when λ was greater than 0.5. Assembly clearance was a factor in this effect. In order to eliminate as much as possible its influence on the measurement error, the original data that with the force larger than 2 N were used to fit. The slopes of the new lines were chosen as the stiffness and add them to FIG. 7 for comparison with other results. It can be seen that the stiffness has improved significantly when the λ was large, and the stiffness ratio reaches 36.94. But there was still some gap compared to the theoretical model and FEA, which was the result of not completely eliminating the clearance of the assembly clearance.

The finger has good variable stiffness performance. For example, for an egg weighing 55 g, the stiffness can be adjusted to the minimum, which will result in a deformation of the finger of about 6.5 mm. But for a stainless steel cup weighing 500 g, the stiffness can be adjusted to the maximum, where the deformation was only about 3 mm. This finger 12 can cope with light and fragile objects, as well as heavy and sturdy objects in daily life. For the former, λ was best selected in the range 0.1 to 0.7, while for the latter, λ can be selected in the range 0.8 to 1.0.

In order to demonstrate the wide applicability of a grasping device using fingers as described above, several daily objects were selected, including a potato chip, an empty bottle, a sponge, an orange, and a striped metal block. Different grasping strategies were adopted for different objects. The chip and empty bottle were light and easily deformed, so the stiffness was adjusted to the minimum. The sponge was very light but not so fragile, so the stiffness can be adjusted slightly higher. The orange was heavier, but in order to avoid damage to its surface, the stiffness was not adjusted too large. The metal block was heavy and does not deform easily, so the maximum stiffness can be chosen.

The investigations described above evidenced the efficacy of a variable-stiffness robotic finger. The design of the finger allowed the compliance thereof to be changed by continuously changing the occupied ratio of the finger space 16 inside a parallel beam mechanism. This mechanism can be driven directly by servo motors or other drive mechanisms to quickly alter stiffness to adapt to new environments in a short time with large stiffness change ratios (for example, around 1:37 based on the tested prototype). A theoretical model of this mechanism was developed and validated with the FEA results with stiffness error less than 6.43%. The effect of multiple design parameters on the stiffness of the finger was investigated and optimal parameters could be selected based on the analysis. Then a prototype finger was manufactured to further investigate the performance of the finger 12 through experiments. At a lower occupied ratio, the experimental prototype and the theoretical model agreed well, but when the occupied ratio was higher, the error increased, which was believed to have been due to manufacturing and assembly errors. The function performance of the grasping device 10 was demonstrated by a group of various representative daily objects. Experiments showed the potential of the finger 12 for a large range of stiffness variation in flexible grasping.

As previously noted above, though the foregoing detailed description describes certain aspects of one or more particular embodiments of the invention, alternatives could be adopted by one skilled in the art. For example, the grasping device 10 and finger 12, as well as and their components, could differ in appearance and construction from the embodiments described herein and shown in the drawings, functions of certain components of the grasping device 10 and finger 12 could be performed by components of different construction but capable of a similar (though not necessarily equivalent) function, and various materials could be used in the fabrication of the grasping device 10 and finger 12 and/or their components. As such, and again as was previously noted, it should be understood that the invention is not necessarily limited to any particular embodiment described herein or illustrated in the drawings.

1. A flexible finger for a robotic grasping device, the flexible finger comprising:
a flexible beam mechanism having an axis extending through a proximal end and a distal end of the flexible finger; and
a slider movably mounted on the beam;
wherein moving the slider along the axis of the flexible beam mechanism changes the stiffness of the finger.

2. The flexible finger of claim 1, wherein the flexible beam mechanism comprises a parallel beam mechanism.

3. The flexible finger of claim 1, wherein the flexible beam mechanism comprises a first beam and a second beam that are parallel to each other.

4. The flexible finger of claim 3, wherein the first beam and the second beam are spaced apart laterally and define a space therebetween.

5. The flexible finger of claim 4, wherein the space extends along axial lengths of the first and second beams and is continuous between the proximal and distal ends of the flexible finger.

6. The flexible finger of claim 5, wherein at least a portion of the slider is disposed in the space.

7. The flexible finger of claim 6, wherein moving the slider toward the distal end of the flexible finger causes the slider to occupy the space and moving the slider toward the proximal end of the flexible finger causes the slider to vacate the space.

8. The flexible finger of claim 7, wherein the stiffness of the finger is changed by changing an occupied ratio, wherein the occupied ratio is a ratio of a volume of the space occupied by the slider to a total volume of the space not occupied by the slider.

9. The flexible finger of claim 8, wherein the stiffness of the finger decreases as the occupied ratio decreases, and the stiffness of the finger increases as the occupied ratio increases.

10. The flexible finger of claim 1, further comprising a drive mechanism for moving the slider continuously along the axis of the flexible beam mechanism.

11. The flexible finger of claim 10, wherein the drive mechanism comprises a stepper motor.

12. A robotic grasping device comprising the flexible finger of claim 1.

13. The robotic grasping device of claim 12, the robotic grasping device further comprising a base portion coupled to the proximal end of the flexible finger.

14. The robotic grasping device of claim 12, further comprising a drive mechanism that extends and retracts the slider in and out of the base portion.

15. The robotic grasping device of claim 12, the robotic grasping device further comprising at least a second flexible finger.

16. A method of adjusting the stiffness of a variable-stiffness robotic finger according to claim 1, the method comprising moving the slider continuously along the axis of the flexible beam mechanism.

17. The method of claim 16, the method further comprising:
moving the slider toward the distal end of the flexible beam mechanism to stiffen the flexible finger; and
moving the slider toward the proximal end of the flexible beam mechanism to make the flexible finger more flexible.
